(19) United States
(12) Patent Application Publication
(10) Pub. No.: US 2022/0107258 A1
(43) Pub. Date: Apr. 7, 2022

(54) Method and apparatus to search for, find, collect and confirm the presence of ptentially dangerous airborne particles such as COVID-19 VIRUS

(71) Applicant: Philip Joseph Wyatt, Santa Barbara, CA (US)

(72) Inventor: Philip Joseph Wyatt, Santa Barbara, CA (US)

(21) Appl. No.: 16/974,113

(22) Filed: Oct. 1, 2020

(51) Int. Cl. G01N 15/02

(52) U.S. Cl. CPC G01N 15/0211; G01N 2015/0065

(57) ABSTRACT

A light scattering method and apparatus are disclosed whereby the presence of the COVID-19 virus in a designated volume of ambient air may be confirmed within a few hours from the analysis of its contents. By such means, the near real-time presence of viral constituents within airborne regions of meetings, gatherings, presentations, and even the ICUs of hospitals themselves, may be confirmed and often quantified. The present invention provides such means to find, separate, and identify specifically such fractions: an important early warning of their presence and the current dangers they pose. The same methods described may be applied also for the detection of airborne bacteria.

### BACKGROUND

The search for, detection, capture, and identification of certain classes of airborne particles, whose presence within a variety of local environments may be life threatening, represent tasks of continuing importance. Among the most dangerous and difficult to find, detect, and identify in situ are the causative viruses of the COVID-19 pandemic affecting most communities in the world. In addition to the COVID-19 viruses, it is expected that there would appear in the near-time future other viral, and even bacterial, airborne threats whose real time detection and localization will become of comparable importance.

A variety of collection devices exist, that may be used to collect a large fraction of the particles present within relatively large selected volumes of ambient air and transfer them into very small volumes of liquids such as water. Many are described, for example, in the recent 2019 article “Collection, particle sizing and detection of airborne viruses” on pages 1596 to 1611 of Journal of Applied Microbiology volume 127. An earlier article providing similar and some additional techniques is “Methods for Sampling Airborne Viruses” on pages 413 to 444 of Microbiology and Molecular Biology Reviews September 2008. Although such collection techniques will provide samples rich in particulates, the means by which the COVID-90-containing fractions therein may be isolated and identified rapidly are not currently available.

Although light scattering techniques are always useful in identifying small particulates, the most difficult problem associated with attempts to detect such dangerous viruses by these techniques is the fact that they are so small (relative the wavelength of traditional scattered light measurement systems). Thus, irrespective of their numbers present, the amount of light scattered by them (relative to that scattered by traditionally present airborne particulates) is negligible.

Therein lays the basic problem: If one could collect all particles, including viruses, contained within a reasonable volume of the accessible ambient air, the significant problem of distinguishing light scattered by the COVID-19 viruses content from that scattered by the larger quantities of their unimportant companion particles would remain.

### BRIEF DESCRIPTION OF THE DRAWINGS

FIG. 1 shows the structure of the preferred asymmetric flow field flow fractionation (A4F) means to fractionate airborne particles collected and captured in a liquid medium.

FIG. 2 shows the flow structure produced by a disposable hollow fiber implementation of the A4F process.

FIG. 3 shows the means by which the light scattered by the components of the A4F fractionated sample is measured as a function of scattering angle.

FIG. 4 shows the scattered light intensity as a function of angle from an indicated particular fraction of an A4F separated adenovirus sample.

### SUMMARY OF THE INVENTION

The particulate contents of a selected region of the air, in which the COVID-19 virus may be present, is collected within a very small volume of water or similar buffered fluid by means of one or more of the virus collection methods described in the two above-cited articles. An aliquot of this collected sample-bearing solution is injected into the buffered aqueous fluid flowing through an asymmetric flow field flow fractionation (A4F) system that separates and elutes the particulate contents of the injected sample by size, from the smallest to the largest. The thus-fractionated particles, in order of elution, would begin with the COVID-19 viruses if present followed by aggregates thereof, fragments of cellular debris perhaps also containing residual virus aggregates, and finally other particulate content in ascending order by size. The particles then pass through a fine laser beam, scattering some of the light incident on them into an array of scattered light detectors. Traditionally, the detectors collect scattered light at a set of angles spanning a range between 0 and 180 degrees. The sizes of the scattering particles are derived from the variation of intensity with angle of the light they scatter. If the shape of the eluting particle is known, this size result may be used to derive further details of its shape. The diameter of the near-spherical COVID-19 virus, for example, is 125 nm. If present in sufficient quantity, the presence of the COVID-19 viruses in the sample injected is confirmed. A 2013 article by Bousse, et al. in volume 193, pages 589 to 596, of the Journal of Virological Methods confirms the ability of A4F to detect and quantitate the specific types of viruses present as elements of a fractionated supernatant solution. In addition to the presence of viral particles, larger aggregates as well as aggregates of other aerosol particulates present will elute in order of increasing size. The distributions of such viral aggregates may be used to confirm further the COVID-19 light scattering and, thereby, its presence.

### DETAILED DESCRIPTION OF THE INVENTION

The outbreaks of COVID-19 infections have continued within a variety of regions, often associated with earlier events such as holiday celebrations, political rallies, religious gatherings, bars, etc. A significant fraction of the population continues to attend such events with no protective masking nor interest in maintaining safe spacing. Additionally, such safety regulations and requirements are often difficult to monitor and enforce within confined areas such as senior retirement centers, professional meetings, some hospitals, treatment centers, etc. The presence of airborne COVID-19 viruses within such regions cannot be confirmed in real-time. However, such viral content is detectable and, within reasonably short time periods, quantified by means of the inventive process disclosed herein.

The search for COVID-19, or similar viruses, begins with the collection of all the particulate contents of a specified spatial region and its transfer into a small volume of water or similar buffered fluid. This collection is by means of one or more of the virus collection methods described in the two cited reviews in the BACKGROUND section above. Following such a collection process, a solution of a few milliliters containing the constituents of the airborne region sampled is ready for processing in order to classify and identify its contents with particular attention to its COVID-19 fraction if present. In order to find the COVID-19 constituents of the collected sample, the injected aqueous sample must be separated into its constituent parts by means of the asymmetric flow field flow fractionation (A4F) process to be described.

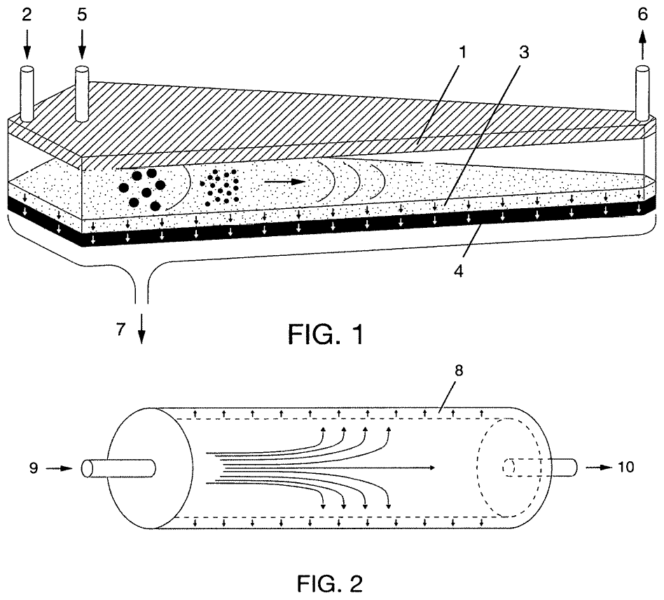

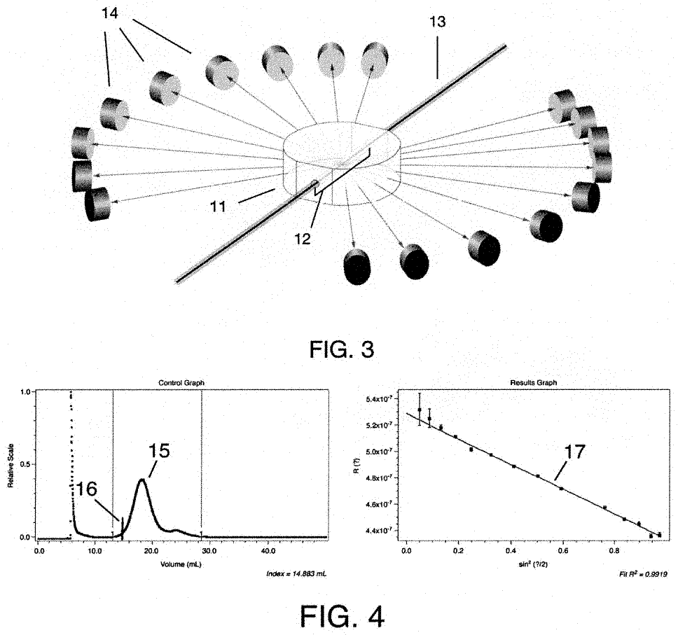

The typical A4F channel, shown in FIG. 1, is defined by an impermeable, generally transparent, top plate 1, and a rigid permeable bottom plate 4 that supports a permeable membrane 3. As the flow enters at 2, it is divided into two components: one component spreads out and flows through the permeable membrane at a constant flow per unit membrane area, while the remainder, containing the fractionated sample, exits the channel at 6, where it then passes through a multiangle light scattering photometer shown in FIG. 3. The particle-containing sample is injected at 5. Because of Brownian motion, the smaller particles will equilibrate further away from the membrane than the larger particles and, accordingly, move through the channel more rapidly than their larger companions whose passage through the channel is slower.

Most of the flow through the permeable plate 4 is controlled by a valve and exits at 7. The channel flow containing the fractionating sample, leaving the channel at 6, is just the difference between the inlet flow 2 and exit flow 7. The particle-containing sample is injected at 5. By controlling the transverse membrane flow exiting at 7, the flow perpendicular to the channel and leaving through the membrane is thus controlled. The injected particles are subject to two flow fields as they move through the channel: The flow through the channel from injection at 2 to exit at 6, and the perpendicular flow that leaves through the rigid permeable plate 4 through 7. The channel structure is generally tapered from entrance to exit to compensate somewhat for the net flow per unit area through 7. During the flow down the channel, the particles are fractionated because of their different sizes and structures.

FIG. 2 presents a simpler type of field flow separation produced by a permeable tube 8. The tube is generally enclosed by a concentric structure that allows control of the total amount of transverse flow through its permeable sides. As the injected sample 9 flows through the permeable tube, it is subjected to an effective transverse flow providing a similar fractionation to that produced by the conventional structure of FIG. 1.

The fractionated samples leaving the FIG. 1 channel at 6 or the FIG. 2 permeable tube structure at 10, will pass through a detection system of the type shown in FIG. 3. This detection system is comprised generally of a flow cell 11 through which a channel 12, collinear with a fine laser beam 13, passes. The light scattered by the sample as it passes through the channel at the center of the detector array is detected by a surrounding array of detectors 14, followed by a concentration detection device such as would be provided by a refractive index or UV detector. The scattered light detectors are most frequently photodiodes.

There are other, more traditional, types of scattered light detection systems. These include an array of detectors surrounding a cylindrical flow cell illuminated by a laser beam perpendicular to the direction of flow there through, with each set at a different angle with respect to the direction of the incident beam of illumination.

The thus-fractionated particles, in order of elution, would begin with the COVID-19 viruses (the smallest) followed by aggregates thereof, fragments of cellular debris perhaps also containing residual virus aggregates, and finally other particulate content in ascending order by size. This solution may contain particulate debris, traces of virus-cell complexes, virus aggregates of various combinations, in addition to the single virus constituents themselves, if present. The size of the members of each such fraction may now calculated from the measurement of light it scatters as a function of scattering angle. The initial slope of said scattered light intensity is directly proportional to the square of particles' size. For example, FIG. 4 shows scattered light data collected by the detector array following the A4F fractionation of a sample of adenovirus. FIG. 4 shows the sample elution 15 as a function of eluting volume with a particular slice indicated at 16 producing the intensity as a function of sin² (θ/2) at 17. The fit of these data to the nearly spherical shape of the virus yields diameter of about 78 nm; certainly smaller than the 125 nm diameter of the COVID-19 virus. The quantitative analyses of the eluting “collection,” most importantly, will provide (at some critical level of viral presence per unit volume collected) early evidence of potential COVID-19 viruses within and adjacent to the volumetric volume whose particulate contents were collected. By these inventive means, the presence of COVID-19 viruses within a defined volume of air will be confirmed.

There are other forms of field flow fractionation by which means samples may be fractionated depending upon their composition. These include electrical, thermal, and gravitational. Details may be found in the text “Field-flow Fractionation Handbook” by M. Schimpf, K Caldwell, and J. C. Giddings.

It is obvious that detection of other health-threatening airborne particles and molecules by the same inventive means described may be achieved using the same sequence of collection, fractionation, and measurement. Among them are the many viruses that affect farm animals such as swine virus. Such airborne health-threatening airborne particles also include bacteria such as those responsible for airborne hospital-acquired infections, seasonal flu viruses whose physical locations relative to those stricken with the disease is rarely considered, asbestos particles, etc. It is of particular interest to note that the common, almost yearly, viruses that cause annual flu epidemics do not receive the attention that the COVID-19 viruses have received. Yet in 2018, for example, 80,000 Americans died of flu infections and their complications; about half of the number killed by COVID-19 virus to date.

1. A method to search for airborne virus particles comprising
a. transferring all particles in a defined volume of air into a small volume of liquid;
b. injecting said small volume of liquid into an asymmetric-flow field flow fractionator whereby the particle contents of said volume of air are fractionated by size as they flow through the asymmetric flow field flow fractionator;
c. flowing said size-fractionated sample through a laser beam after leaving the asymmetric flow field flow fractionator;
d. measuring scattered light intensities for the size-fractionated sample passing there through at each different angular element of a surrounding array of scattered light detectors;
e. deriving a size of each element of the size fractionated sample from an angular variation of light scattered therefrom; and
f. confirming a virus source of each size fractionated sample whose size corresponds to the size associated with said virus particles and/or the said virus particle aggregates.

2. The method of claim 1 where said virus particles are of the COVID-19 genus.

3. The method of claim 1 where said virus particles are of common flu origin.

4. The method of claim 1 where said virus particles are of swine flu genus.

5. The method of claim 1 where said liquid is water.

6. The method of claim 5 where said water is buffered.

7. A method to search for airborne bacteria comprising
a. transferring all particles in a defined volume of air into a small volume of liquid;
b. injecting said small volume of liquid into an asymmetric-flow field flow fractionator whereby the particle contents of said volume of air are fractionated by size as they flow through the asymmetric flow field flow fractionator;
c. flowing said size-fractionated sample through a laser beam after leaving the asymmetric flow field flow fractionator;
d. measuring scattered light intensities for each fractionated sample passing there through at each different angular element of a surrounding array of scattered light detectors;
e. associating the scattered light intensities measured as originating from bacteria
f. deriving a size and structure of each fractionated sample element from angular variation of light scattered therefrom; and
g. confirming an airborne bacterial source of each thus-sized eluting sample fragments whose size and structure corresponds to those associated with said bacterial particles and/or their aggregates sought.
